(19) United States
(12) Patent Application Publication
(10) Pub. No.: US 2018/0005151 A1
(43) Pub. Date: Jan. 4, 2018

(54) ASSET HEALTH MANAGEMENT FRAMEWORK

(71) Applicant: General Electric Company, Schenectady, NY (US)

(72) Inventors: Linxia LIAO, San Ramon, CA (US); Hyung-il AHN, San Ramon (NY)

(21) Appl. No.: 15/197,394

(22) Filed: Jun. 29, 2016

(51) Int. Cl. G06Q 10/06; G06Q 40/06

(52) U.S. Cl. CPC G06Q 10/0637; G06Q 40/06

(57) ABSTRACT

A system, medium, and method including receiving sequential data relating to one or more assets, the sequential data including state information of the one or more assets over a period of time; determining at least one dependency in the sequential data; optimizing parameters of the sequential data of the one or more assets; and generating, by a survival model, an indicator of a health assessment for the one or more assets.

### BACKGROUND

As the Internet-of-Things and other advances in technology more readily enables us to obtain a great amount of data to monitor physical assets, there is an increasing demand for determining asset health conditions in a variety of industries. Accurate asset health assessment may be considered a key element that facilitates a predictive maintenance strategy to increase productivity, reduce maintenance costs and mitigate safety risks.

Some analytics models for asset health assessment in the literature have relied on historical operating data, sensor data and maintenance action logs. For example, a principal component analysis (PCA) has been used to identify key factor values such as the state of dissolved gasses and then a back-propagation neural network model was utilized to predict asset health condition using the identified key factor values. Some have presented a health trend prediction approach for rotating bearings where an empirical mode decomposition method was used to extract features from vibration signals and then a self-organizing map method was used to calculate a coincidence value of the bearing health state based on the extracted features. Others have described a method to predict cutting tool wear where a nonlinear feature reduction method was used to reduce the dimension of the original features extracted from the monitoring signal, and then a support vector regression method was used to predict the cutting tool wear based on the reduce features. Still others have proposed a method to predict battery health condition by a wavelet denoising approach to reduce the uncertainty and to determine trend information and then using a relevance vector machine as a nonlinear time-series prediction model to predict the remaining life of the battery. Yet another proposed the framework of building a vital sign indicator using “individualized” cumulative failure probability involved two separate steps of classification and regression, where the classification step was first used to calculate the classification failure probability as a way of dimensionality reduction and then the regression step (e.g. Cox proportional hazard regression or support vector regression), given the classification probability as an input variable, estimated the optimized hazard function and the individualized cumulative failure probability.

In general, previous models tend to have two separate steps such as feature extraction and prediction. The two-step approach involves two separate optimization procedures that often requires the iteration of the two separate procedures until any acceptable result is achieved.

### BRIEF DESCRIPTION OF THE DRAWINGS

FIG. 1 is an example embodiment block diagram of a framework;

FIG. 2 is an illustrative flow diagram of a process, according to some embodiments;

FIG. 3 is an example graphical plot of data according to some embodiments herein;

FIG. 4 is a graphical plot of data for an example use-case according to some embodiments herein;

FIG. 5 is another graphical plot of data for an example use-case according to some embodiments herein; and

FIG. 6 is a block diagram of an apparatus, according to some embodiments.

### DETAILED DESCRIPTION

The following description is provided to enable any person in the art to make and use the described embodiments. Various modifications, however, will remain readily apparent to those in the art.

In some aspects of the present disclosure, one embodiment includes a method to integrate feature extraction and prediction as a single optimization task by stacking, for example, a three layer model as a deep learning structure. In one embodiment, a first layer of the deep learning structure herein is a Long Short Term Memory (LSTM) model that receives sequential input data from a group of assets. The output of the LSTM model may be followed by mean-pooling the outputs of the LSTM model with the result being fed to a second layer. The second layer may be a neural network layer that further learns the feature representation(s) of the sequential data. The output of the second layer may be fed to a third, survival model, layer for predicting an asset health condition of the assets. In some aspects, parameters of the three-layer model are optimized together via, for example, a stochastic gradient decent process.

Embodiments of the present disclosure model or framework may provide an “individualized” failure probability representation for indicating or assessing the health condition of each individual asset.

In the context and application of asset health assessment, input data may be formatted as sequential data. As used herein, sequential data includes time sequenced or time interval data comprising a sequence of measurements obtained over a period of time. In some regards, the time period can include any time from the installation of a piece of equipment or asset being monitored to the end of the asset's operation. In other words, the time period can be any time during the operational life-cycle of the asset. For example, the sequential data may be a temperature, voltage, pressure, current, or other measurements, utilization, and events relating to a state of an asset over a period of time. It is noted that Long Short Term Memory (LSTM) may be well-suited to learn the past dependencies in the sequential data that may influence future events (e.g., a failure of the asset). Asset health management also often involves modeling on the data from a fleet of multiple assets where some have different life cycles, for which survival analysis may be suitable. In some embodiments herein, an “end-to-end” deep learning structure is disclosed that stacks LSTM, a feature learning neural network, and survival analysis, and optimizing all the parameters together using, for example, stochastic gradient descent to generate an optimized result.

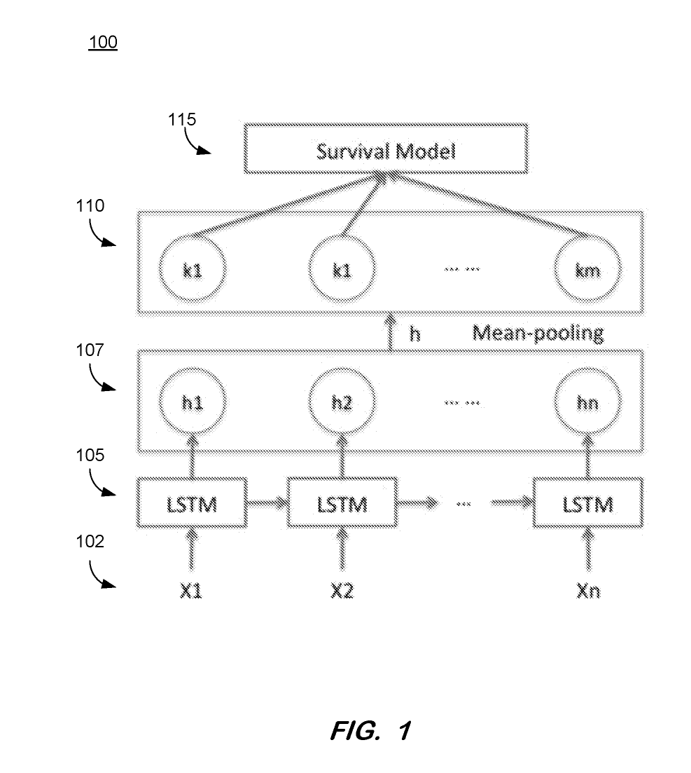

FIG. 1 is an example embodiment of a framework 100 herein that integrates feature extraction and prediction as a single optimization task by stacking a LSTM layer 105, a feature learning neural network layer 110, and a survival model layer 115. The LSTM layer 105 receives raw sequential data input 102 from one or more assets (e.g., turbines, engines, aircraft, network or computer systems and/or components, etc.) and extracts the features thereof. In some aspects, the LSTM layer 105 converts the raw signal measurements monitored and recorded over a period of time to an intermediate output representation or indicator 107 (i.e., h₁, h₂, . . . hₙ). As an example, at least one of a temperature, a voltage, a current, a pressure, and other state information and the like of a piece of equipment (i.e., asset) can be measured once a day for 2 years (e.g., a sequence of more than 700 measurements).

In some embodiments, mean-pooling may be used on the extracted features output by the LSTM layer 105 to generate input for an extra neural network layer 110 to further learn the feature representation(s) of the assets based on the sequential data. The output of the feature learning neural network layer 110 is input into the survival model layer 115 that generates and outputs a failure probability to indicate a health condition of the one or more assets corresponding to the sequential data. In some aspects, the learning method performed or executed by the framework 100 optimizes all of the parameters using a stochastic gradient descent method.

In some aspects, the layers of framework 100 may be logical layers or representations of an architecture. As such, the layers of the framework may be implemented by processes according to some embodiments, and actual implementations may include more or different components arranged in a variety of manners. Different topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code or instructions such that the computing device operates as described herein.

In some embodiments of framework 100, LSTM layer (or module) 105 is a type of Recurrent Neural Network (RNN) that can be applied in many applications. In some aspects, a loop in the RNN allows information to pass from one step of the network to the next. The persistence of this information enables RNNs to reason using previous information to infer a later event (e.g., a failure of an asset). In some respects, a LSTM is a special type of RNN structure designed to learn long-term dependencies, e.g. when there are very long time lags between important events.

In some embodiments, instead of using a single layer as in standard RNNs, LSTMs 105 may use four special and interacting layers, which are f, l, \tilde{C}, and o. The first layer, f, is a sigmoid layer called the “forget gate layer” that determines what information needs to be passed from the previous state (Cₜ₋₁). This layer looks at the previous output hₜ₋₁ and a current input xₜ, and outputs a number between 0 and 1. The equation of the first layer can be denoted by:

fₜ=σ(W_{f}·[hₜ₋₁, xₜ]+b_{f}), (1)

where σ is the sigmoid function, W_{f} is the weight of layer f, [symbol] denotes the concatenate operation, and b_{f} is the bias of layer f.

The second layer (i) of the LSTM layer 105 decides what information is to be stored in the current state. In some aspects, there can be two steps. First, a sigmoid layer i is used to decide which value to be updated, such that:

iₜ=σ(Wᵢ·[hₜ₋₁, xₜ]+bᵢ), (2)

where σ is the sigmoid function, Wᵢ is the weight of layer i, and bᵢ is the bias of layer i. Secondly, a tan h layer c updates the values to be stored using:

C̅ₜ=tan h(W_{c}·([hₜ₋₁, xₜ]+b_{c}), (3)

where tan h is the tangent function, W_{c} is the weight of layer c, and b_{c} is the bias of layer c. Now, the previous state (Cₜ₋₁) can be updated to the current state (Cₜ) using:

Cₜ=fₜ·Cₜ₋₁+iₜ·C̅ₜ), (4)

The last layer is a sigmoid layer (o) to determine the output of the current state. The equation of layer (o) is denoted by:

σₜ=σ(Wₒ·[hₜ₋₁, xₜ]+bₒ) (5)

where sigma is the sigmoid function, Wₒ is the weight of layer o, and b₀ is the bias of layer o.

The final output (hₜ) is determined by:

hₜ=oₜ·tan h(Cₜ), (6)

LSTM layer 105 serves as the first layer of framework 100, as shown in FIG. 1. A purpose may be to receive and process the sequential data and potentially capture information in the past that may contribute to a later event (e.g., a failure).

In some embodiments, the output hₜ is averaged (mean-pooling) over time as the feature representation for further steps as represented by:

h=Σⱼ₌₁ⁿh_{j/n}, (⁷)

where hⱼ is the output of the jth sequence and n is the length of the entire sequence input. In some aspects, h captures dependencies in the sequence of measurements to the future event (e.g., asset failure). In some regards, h is an “intermediate” output of the framework.

Referring still to FIG. 1, feature learning layer 110 is a generative layer (k) that can further learn the feature representation h outputted by LSTM layer 105. In some regards, there may be many different possible designs for layer 110. In one aspect, it can either be a single layer or multiple layers. Additionally, the number of neurons m can be selected differently. Also, the activation function for each layer can be different as well. For simplicity (and not as a limitation), a single sigmoid layer (k) can be used in some embodiments of a framework herein. In some embodiments, an equation for layer k is denoted by:

P=σ(Wₖ·h+bₖ), (8)

where σ is the sigmoid function, Wₖ is the weight of layer k, h is the output of Equation 7, and bₖ is the bias of layer k. In some aspects herein, feature learning layer 110 transforms the “intermediate” result, feature h, into a refined or optimized feature representation k.

In some aspects herein, feature learning layer 110 is an optional aspect of framework 100.

Regarding survival model layer 115, a survival model can use analysis to determine the expected time duration until any event happens. Sequential data contains information about events and the time when the events occurred. In the context of an asset health management application, an event happens when, for example, an asset fails. The sequential data measures any signal that is related to the operation or condition (i.e., state) of the asset over time. As such, a survival model may be well-suited to asset health management applications in some embodiments herein.

In some regards a sojourn time (i.e., a time spent in a certain state) in the survival model layer 115 in some embodiments herein may be assumed to follow a Weibull distribution. A Weibull distribution is widely accepted for product reliability analysis. The hazard rate for sojourn time t is:

$$α ( t ) = \frac{Λ}{λ} {( \frac{t}{λ} )}^{Λ - 1} \qquad ( 9 )$$

where Λ is the shape parameter, and λ is the scale parameter. The hazard rate can be adapted to model various sojourn time dependent hazard risks.

In some aspects, the sojourn time may also be influenced by observed covariates such as the measured signals from the asset or the extracted feature representation from the measurements. The impact of the covariates may be modeled using the Cox proportional hazard model:

a(t|P)=α(t)e^{βP} (10)

where α(t) is the baseline hazard rate defined by the Weibull distribution, P is a vector of covariates, and β is a vector of the coefficients of the covariates. It is noted that P is the output of Equation 8.

In some survival models, large portion of the observations are censored. Right censoring is the most common censoring form, for when the study ends before any event happens. In some embodiments of the present disclosure, the asset's sequential data is used for survival analysis. Censoring is mainly caused by the incompleteness of the observation of the failed assets. The asset's health condition after the time period of the observation is unknown, hence it is “censored”. The right censoring case in some embodiments herein is censored by the last time stamp of the data observed when an asset has not yet failed. In other words, how much longer can this asset remain in service in unknown.

In some embodiments, censoring can be modeled by cumulative probability functions that integrates all possible outcomes. As such, the likelihood function for the assets may be defined by:

L=√_{ι=1}^{N}α(t_{ι}|P_{ι})^{1-δ}·H(t_{ι}) (11)

where N is the total number of assets, α(t_{ι}|P_{ι}) is the probability density that the asset will fail at the time t_{ι}given its covariates P_{ι}, and is the indicator for right censoring. It equals to 1 if the asset has not yet failed and otherwise equals 0. H(t_{ι}) is the probability that the asset stays in service for more than t_{ι}and can be represented as follows:

H(t_{ι})=∫ₜ_{_{ι}}^{∞}α(t_{ι}|P_{ι})dt (12)

As used herein, the failure probability indicates an asset's health condition. In some embodiments herein, the failure probability is defined by:

F(t_{ι})=1∫_{tι}^{∞}α(t_{ι}|P_{ι})dt (13)

The objective of the learning is to minimize the negative log likelihood defined in Equation 11. Accordingly:

cos t=−log (L)=−log (Π_{ι=1}^{N}α(t_{ι}|P_{ι})^{1-δ}·H(t_{ι})) (14)

The covariates (P_{I}) for each asset is derived from the original sequential data by passing through the LSTM layer 105 and the feature learning layer 110. The learning process is, in some embodiments, governed by a stochastic gradient descent method. It is noted that the learning process can directly minimize the final cost function using the original data, which means the feature extraction and the asset health assessment aspects herein may be optimized together in the learning process. That is, the integrated feature extraction and the asset health assessment aspects of framework 100 are optimized in a single “step” herein.

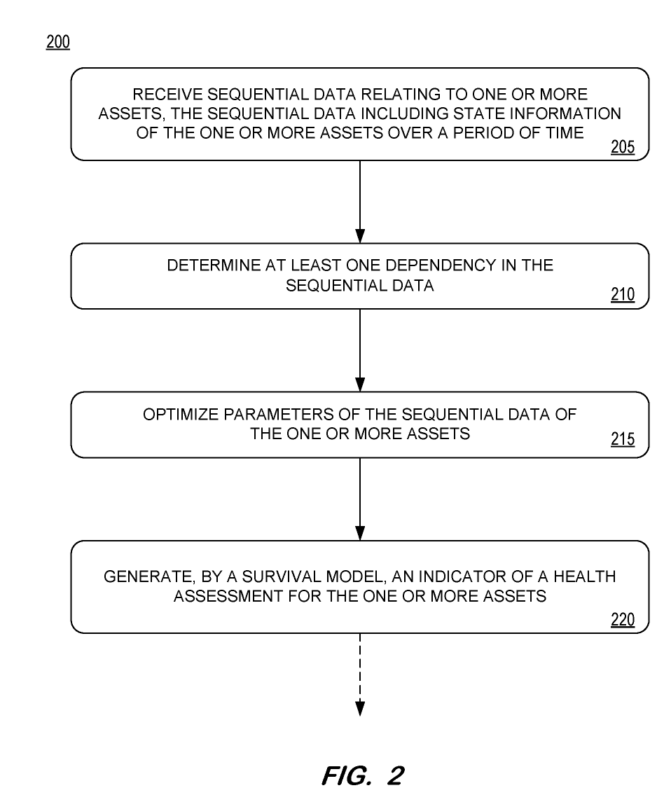

FIG. 2 is an example flow diagram of a process 200 for an example embodiment herein. Process 200 may be implemented by a framework (e.g., framework 100) and/or a system or device (e.g., 600) herein. At operation 205, process 200 receives sequential data relating to one or more assets. The assets may be one or more devices, systems, and components, which might comprise one or more other devices, systems, and components. The assets may include, for example, at least one mechanical, electrical, electro-mechanical, biological, and other systems, devices, and components, either alone and in combination. The sequential data includes state information associated with the one or more assets over a period of time. In some aspects, the sequential data may include raw sensor measurements or signals obtained via sensors interfaced with the assets being monitored over a period of time. In some embodiments, the sequential data may be received from a data store, directly from the assets, from a third party service provider, open data sources, and combinations thereof.

Process 200 proceeds to operation 210 where a determination is made, based on the sequential data, of at least one dependency in the sequential data. As related to the asset health management context in some embodiments herein, operation 210 may determine a dependency in the sequential data and an event, wherein an event in this context refers to a failure of the asset related to the sequential data.

Operation 215 includes optimizing parameters of the sequential data of the one or more assets. As explained above, a learning aspect of the framework methodology disclosed herein may optimize the feature extraction and asset health assessment aspects herein (See equation (14)).

Process 220 may include, at operation 220, survival analysis such as, for example a survival model. The survival model may generate an indicator of a health assessment for the one or more assets related to the sequential data obtained at operation 205. In some embodiments, the indicator may be at least one of a failure probability, a survival probability, a cumulative failure probability, a hazard rate, and a cumulative hazard rate, each to indicate a health assessment for the one or more assets.

In some embodiments, the particular indicator generated may be determined at the time of an implementing system's or application's design. In some embodiments, the implementing system or application may generate a particular indicator in reply to a user's (e.g., an end-user, a system administrator, and other entities) specified preference. In general, the term failure probability refers to an indication of the probability that a failure occurs in a specified interval given no failure before time t; the term survival probability refers to an indication that an asset does not fail (i.e., survives) until a time t or later; the term cumulative failure probability refers to an indication of an asset surviving past each subsequent interval of a time t; the term hazard rate refers to an indication of the event rate at time t conditional on survival until a time t or later; and the term cumulative hazard rate refers to an indication of the cumulative number of expected events over time. It is noted that each of these “indicators” may be computed using different techniques, including those now known and those that become known.

The indicator generated at operation 220 may be persisted in a record, included in a report, and used in a further process (all indicated by the dashed arrow exiting operation 220).

Applicant(s) hereof have realized and validated the framework disclosed herein. In particular, a first case study validated some of the disclosed methods on a small dataset collected from a fleet of mining haul trucks. The results of the first case study include an “individualized” failure probability representation for assessing the health condition of each individual asset (i.e., haul truck), which clearly separates the in-service and failed trucks. This case study demonstrates the expected result are achieved by the disclosed framework. A second case study validates the framework disclosed herein on an open source hard drive dataset in an effort to illustrate the performance of the framework with a large dataset.

Regarding the first case study, the asset health management deep learning structure or framework disclosed herein was tested with one of the largest mining service companies in the world. The collected data includes logs of daily fuel consumption, daily number of loads moved, daily meter hours, and empty drive distance for 27 mining haul trucks over the period from Jan. 1, 2007 to Nov. 11, 2012. Each truck was equipped with a set of sensors triggering events on a variety of vital machine conditions. All of the records collected from a truck form a set of sequential data. Of note, the estimated overall cost of downtime for one of these haul trucks amounts to about 1.5 million USD per day. Therefore, the financial impact of reducing the downtime for these mining haul trucks can be very significant. As such, a goal of this first case study was to assess the health condition of the assets given the collected data and to estimate their future failure probability, in an effort to guide maintenance best practice(s).

The data relating to the mining haul trucks was prepared for processing by normalizing the service time of the trucks to a number ranging from 0 to 1, according to the maximum length of the sequences. Shorter sequences were padded by zeros to ensure the same length on the input sequences. The four most important variables of the data were selected for this study. Due to confidentiality aspects related to the data, the actual names of the variables are not disclosed. However, the variables were also normalized to numbers ranging from 0 to 1 given their minimum and maximum values. It is noted that trucks that had not yet failed at the time stamp of the last measured log entry are labeled for right censoring. The data was separated into two sets by using 70% of the data for a training model, and the remaining of the data for testing. Due to the limited number of samples (i.e., 27 haul trucks), this case study did not use a separate validation dataset.

Regarding this first case study, the asset health management framework was implemented using Theano Python. It is noted that there is no well documented guidance to selecting the parameters of the deep learning model. As such, a trail-and-error process was used to select the training parameters. The learning rate was set to 0.0001 and the model was run until the cost did not decrease for 5000 steps of learning. The number of neurons in the feature learning layer was set to 1 (arbitrarily). Also, the batch size for the stochastic gradient descent learning is set to 10.

After the training finished, the testing data was input to the trained model to calculate the failure probability for validation purposes. Of note, the failure probability of the training data was also inputted to the trained model to validate the training result.

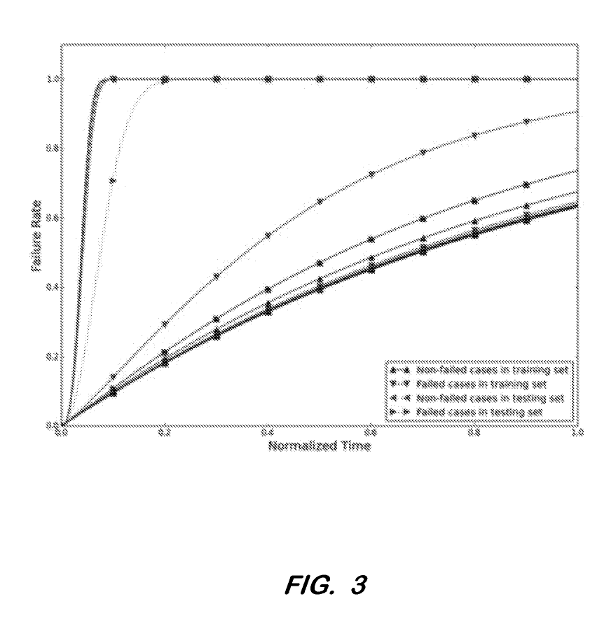

Ideally, the failed trucks should have higher failure probabilities than the trucks that did not fail during the monitored time period, which is defined in Equation 13. The failure probabilities for this case study are shown in FIG. 3, and a summary of the results is shown in the following Table 1.

TABLE 1

| | Non-failed cases | Low failure probability |
|---|---|---|
| Training Set | 14 | 14 |
| Testing Set | 5 | 4 |
| | Failed cases | High failure probability |
| Training Set | 6 | 4 |
| Testing Set | 2 | 1 |

Referring to FIG. 3, for the training set the non-failed cases are shown in the curves marked with up-facing triangles. All of the non-failed cases are shown clustered at the bottom of FIG. 3. The failed cases in the training set are shown in the curves marked with down-facing triangles. As seen, most of the failed cases in the training set are shown in the left upper plot lines. One failed case is seen in the middle of graph 300, and this failed case curve is still higher than the other curves corresponding to the non-failed cases at the bottom of the graph. It is noted that two of the failed cases in the training set are mixed with the curves of the non-failed cases, indicating that these two cases are not separable.

Regarding the testing set, the non-failed cases are shown in the curves marked with left-facing triangles. As shown, only one of these curves is mixed with the failed cases curves located in the upper left portion of FIG. 3. This means that the result for this case is not good. Also, all the other non-failed cases in the test data are embedded with the up-facing triangles indicative of the non-failed cases. This scenario means the results are good since they have similar failure probabilities as other non-failed cases. The failed cases in the test data (i.e., two events) are shown in the curves marked with the right facing triangles. As shown, it is clear that one of the results is good since the failure probability is high. However, the other result is in the region with the up-facing triangles curves (i.e., non-failed training set curves), which is not good.

As a consequence of the data results plotted in FIG. 3, it is clear that the training and testing results demonstrate that the asset health assessment framework disclosed herein can achieve acceptable separation between the non-failed and failed cases for the data set of the present example case study.

In a second case study, the framework herein was tested using a data set much larger than the data set of the first case study. For the second case study, an open sourced reliable dataset for 41,000 hard drives from a data center was used. For these monitored hard drives, a new hard drive of the same model is used to replace failed drives and they in turn are run until they fail. Data was recorded daily from year 2013 to year 2015. Each datatum in the data set includes date, serial number, model, capacity, failure, and S.M.A.R.T. (Self-Monitoring, Analysis and Reporting Technology) statistics and their normalized values, including statistics such as reallocated sectors count, write error rate, and temperature, etc.

Regarding preparation of the data related to the hard drives for processing by the disclosed framework, it is noted that in 2015 additional S.M.A.R.T. columns were added to the data files. Therefore, to maintain consistency in the data set over the entire period of time corresponding to the sequential data, data from 2013 to 2014 was used (i.e., excluded 2015 data). During this period of time, model ST3000DM001 hard drives had the most failures as compared to other models. As such, the analysis in the second case study focuses strictly on data from this model.

For the second case study, the data set included U.S. Pat. No. 2,080,654 rows of data. After dropping columns that had a N/A value, 5 columns of S.M.A.R.T. raw statistics remained (columns numbered as 1; 5; 9; 194; and 197). Each column of the S.M.A.R.T. raw statistics was normalized by subtracting the minimum value and dividing by the difference between the maximum value and minimum value of each column. Additionally, there is another column referred to as “failure” that indicates whether the hard drive has failed (1) or not (0). In total, there were 4703 hard drives of which 1614 failed.

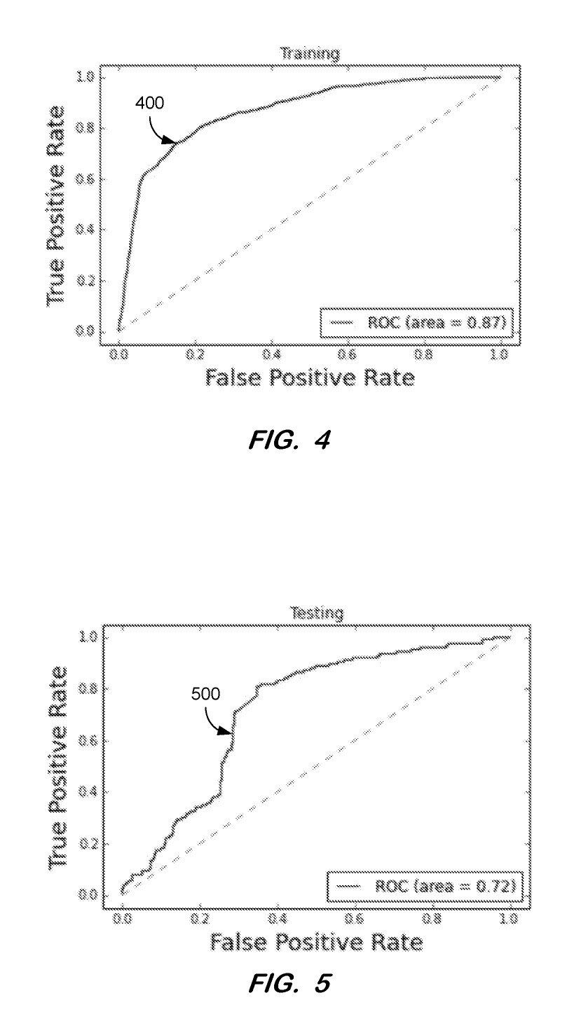

A 5-fold stratified cross validation test was performed on the dataset. That is, the data was separated into 5 folds and the model was trained on 4 and tested on the other, wherein this procedure was repeated for the different combinations. The training parameter selection involved trial-and-error. The learning rate was set to 0.001 and the model was run until the cost did not decrease for 500 steps of learning. The number of neurons in the feature learning layer was set to 1. The batch size for the stochastic gradient descent learning was set to 0.001. The failure probability at the last recorded time was calculated for each hard drive. The average Receiver Operating Characteristic (ROC) curves and area under the curve are calculated for both the training and testing dataset from all the 5 folds. The results for the training dataset is shown in FIG. 4 and the results for the testing dataset is shown in FIG. 5. It is noted that the area under the curves 400 and 500 for training dataset and the testing dataset are 0:87 and 0:72, respectively. Accordingly, this case study demonstrates that the disclosed framework is acceptable (i.e., good correlation and predictor) and can be used for future asset health assessment predictions, including large datasets.

In some aspects, the deep learning framework structure that is disclosed herein to predict asset failure probability learns the feature representation of the sequential data and prediction task together using stochastic gradient decent. No separate feature extraction is needed. In some aspects, the disclosed processes herein provide an “end-to-end” prediction model using sequential data. In some embodiments, it is noted that while a two-state model has been used in the example survival analysis herein (i.e., failure and non-failure states), the framework and processes disclosed herein can be extended to address use-cases with multiple states by modifying the likelihood function defined in Equation 11. It is noted that a multi-state model may have transition probabilities among states as part of the parameters to learn. As the probabilities are bound within 0 to 1, constraints should be set in the learning process. For example, if an optimization with multiple non-equality constraints is not well supported in the deep learning package, alternative methods can be considered. The alternatives might use a hard boundary on the parameters, Gibbs sampling, or other techniques that might will take much longer time to train the model framework.

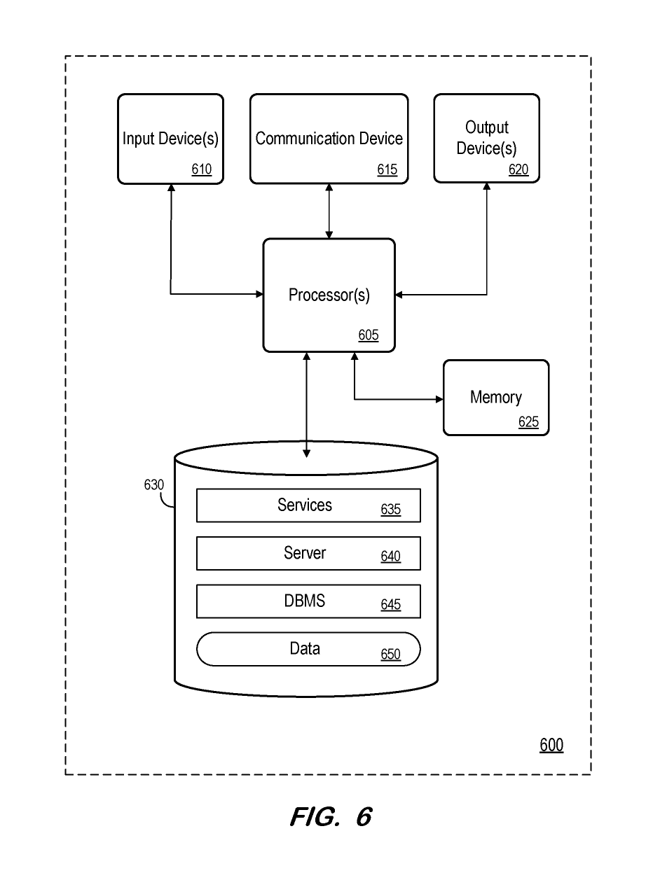

FIG. 6 is a block diagram of apparatus 600 according to some embodiments. Apparatus 600 may comprise a computing apparatus and may execute program code or instructions to perform any of the processes and functions described herein. Apparatus 600 may comprise an implementation of a server to deliver a service and execute an application, a DBMS to manage and organize a set of data (e.g., sequential data relating to one or more assets), a client device interfaced with a cloud-based service, and a data store to persist at least some data and processing results in some embodiments. Apparatus 600 may include other unshown elements according to some embodiments.

Apparatus 600 includes processor 605 operatively coupled to communication device 620, data storage device 630, one or more input devices 610, one or more output devices 620 and memory 625. Communication device 615 may facilitate communication with external devices, such as an asset reporting measurement signals, a data storage device, or a third party provider of data (e.g., sequential data including historical asset measurements recorded over a period of time). Input device(s) 610 may comprise, for example, a keyboard, a keypad, a mouse or other pointing device, a microphone, knob or a switch, an infra-red (IR) port, a docking station, and/or a touch screen. Input device(s) 610 may be used, for example, to enter information into apparatus 600. Output device(s) 620 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 625 may comprise Random Access Memory (RAM), Storage Class Memory (SCM) or any other fast-access memory.

Services 635, server 640 and DBMS 645 may comprise program instructions executed by processor 605 to cause apparatus 600 to perform any one or more of the processes described herein. Embodiments are not limited to execution of these processes by a single apparatus.

Data 650 (either cached or a full database) may be stored in volatile memory such as memory 625. Data storage device 630 may also store data and other program instructions for providing additional functionality and/or which are necessary for operation of apparatus 600, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A computer-implemented method of asset health management, the method comprising:
receiving sequential data relating to one or more assets, the sequential data including state information of the one or more assets over a period of time;
determining at least one dependency in the sequential data;
optimizing parameters of the sequential data of the one or more assets; and
generating, by a survival model, an indicator of a health assessment for the one or more assets.

2. The method of claim 1, wherein the period of time can correspond to any time during an operational life-cycle of the one or more assets.

3. The method of claim 1, wherein the sequential data is time sequenced data.

4. The method of claim 1, wherein the determining of the at least one dependency in the sequential data is executed by a long short term memory layer.

5. The method of claim 1, further comprising determining feature representations of the at least one dependency in the sequential data and generating the failure probability based on the feature representations.

6. The method of claim 1, wherein the at least one dependency in the sequential data is a long term dependency.

7. The method of claim 1, wherein the indicator of a health assessment is at least one of a failure probability, a survival probability, a cumulative failure probability, a hazard rate, and a cumulative hazard rate, each to indicate a health assessment for the one or more assets.

8. A system comprising:
a long term short term memory layer to receive sequential data relating to one or more assets and to determine at least one dependency in the sequential data, the sequential data including state information of the one or more assets over a period of time; and
a survival model layer to generate an indicator of a health assessment for the one or more assets, wherein parameters of the sequential data of the one or more assets are optimized.

9. The system of claim 8, wherein the period of time can correspond to any time during an operational life-cycle of the one or more assets.

10. The system of claim 8, wherein the sequential data is time sequenced data.

11. The system of claim 8, further comprising a feature learning layer determining feature representations of the at least one dependency in the sequential data and generating the failure probability based on the feature representations.

12. The system of claim 8, wherein the at least one dependency in the sequential data is a long term dependency.

13. The system of claim 8, wherein the indicator of a health assessment is at least one of a failure probability, a survival probability, a cumulative failure probability, a hazard rate, and a cumulative hazard rate, each to indicate a health assessment for the one or more assets.

14. A non-transitory computer-readable medium storing processor executable instructions, the medium comprising:
instructions to receive sequential data relating to one or more assets, the sequential data including state information of the one or more assets over a period of time;
instructions to determine at least one dependency in the sequential data;
instructions to optimize parameters of the sequential data of the one or more assets; and
instructions to generate, by a survival model, an indicator of a health assessment for the one or more assets.

15. The medium of claim 14, wherein the period of time can correspond to any time during an operational life-cycle of the one or more assets.

16. The medium of claim 14, wherein the sequential data is time sequenced data.

17. The medium of claim 14, wherein the determining of the at least one dependency in the sequential data is executed by a long short term memory layer.

18. The medium of claim 14, further comprising instructions to determine feature representations of the at least one dependency in the sequential data and instructions to generate the failure probability based on the feature representations.

19. The medium of claim 14, wherein the at least one dependency in the sequential data is a long term dependency.

20. The medium of claim 14, wherein the indicator of a health assessment is at least one of a failure probability, a survival probability, a cumulative failure probability, a hazard rate, and a cumulative hazard rate, each to indicate a health assessment for the one or more assets.
